(19) United States
(12) Patent Application Publication
(10) Pub. No.: US 2011/0162206 A1
(43) Pub. Date: Jul. 7, 2011

(54) METHOD FOR CONNECTING HEAT-DISSIPATING FIN AND HEAT PIPE

(76) Inventor: Shyh-Ming Chen, Taipei County (TW)

(21) Appl. No.: 12/683,451

(22) Filed: Jan. 7, 2010

(51) Int. Cl. B23P 11/00; B23P 15/26

(52) U.S. Cl. 29/890.046; 29/428

(57) ABSTRACT

In an embodiment of the invention, a slot is disposed at a side of a fin. Both sides of the slot separately extend two positioning portions. After a heat pipe is placed in the slot, a mold presses the fin to make the positioning portions bent inwards. The heat pipe is gripped by the deformed positioning portions. In another embodiment, peripheries of the positioning portions are formed into guiding grooves separately, and the mold is provided with two protrusions corresponding to the guiding grooves. The guiding grooves are inserted by the protrusions when the mold is pressing the fin. The part between the positioning portions and slot is inwards deformed to grip the heat pipe.

### BACKGROUND OF THE INVENTION

1. Technical Field

The invention generally relates to coolers, particularly to coolers having a heat pipe and fin.

2. Related Art

With continuous advance of performance of semiconductors and electronic apparatuses, their heat generation is also increasing. This promotes requirement of heat dissipation of semiconductors or LEDs to become tougher than ever. On the other side, electronic apparatuses always tend to be lighter, thinner, shorter and smaller. This further limits the occupying space of a cooler. Therefore, performance of coolers suffers serious challenge.

To maximize the performance of coolers in a limited space, heat dissipation fins must be associated with heat pipes which can rapidly transfer the heat. A heat pipe must tightly connect with a fin so that the heat transfer can be made. However, just a linear connection can be formed between a fin and a heat pipe. A conventional connecting method is to solder the fin and heat pipe. But this method is complicated. The solder must be applied on each fin first, and then heat the solder to make it molten. Furthermore, the molten solder can not flow uniformly. Usually, the solder between the fin and heat pipe is irregular or even gappy. Thus a tight connection is difficult to be formed. For a manufacture of coolers, this connecting method is so uneconomical.

Another conventional connecting method is disclosed by Taiwan patent No. M268111. The fins are provided with a through hole for being penetrated by a heat pipe. The heat pipe is compressed by a mold to be deformed and then to be connected with the fins. However, the copper-platinum layer on the inner side of the heat pipe tends to be shed while the heat pipe is being pressed.

### SUMMARY OF THE INVENTION

A primary object of the invention is to provide a method for connecting a fin and a heat pipe, which can rapidly and simply form a tight connection between a fin and a heat pipe. The production efficiency can be improved.

Another object of the invention is to provide a method for connecting a fin and a heat pipe, which can maintain the connection to be tight and regular.

To accomplish the above objects, in an embodiment of the invention, a slot is disposed at a side of a fin. Both sides of the slot separately extend two positioning portions. After a heat pipe is placed in the slot, a mold presses the fin to make the positioning portions bent inwards. The heat pipe is gripped by the deformed positioning portions. In another embodiment, peripheries of the positioning portions are formed into guiding grooves separately, and the mold is provided with two protrusions corresponding to the guiding grooves. The guiding grooves are inserted by the protrusions when the mold is pressing the fin. The part between the positioning portions and slot is inwards deformed to grip the heat pipe.

### BRIEF DESCRIPTION OF THE INVENTION

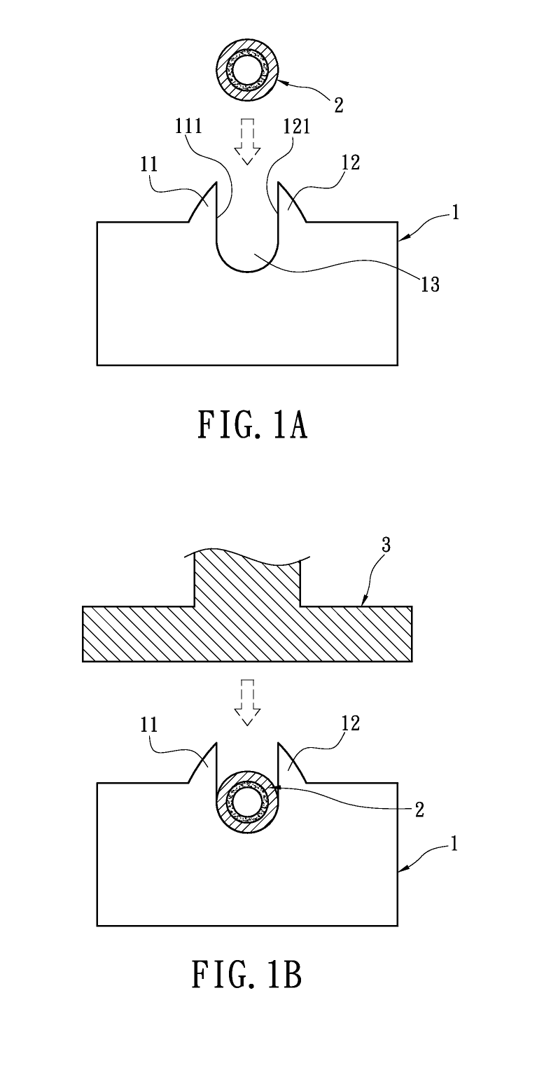

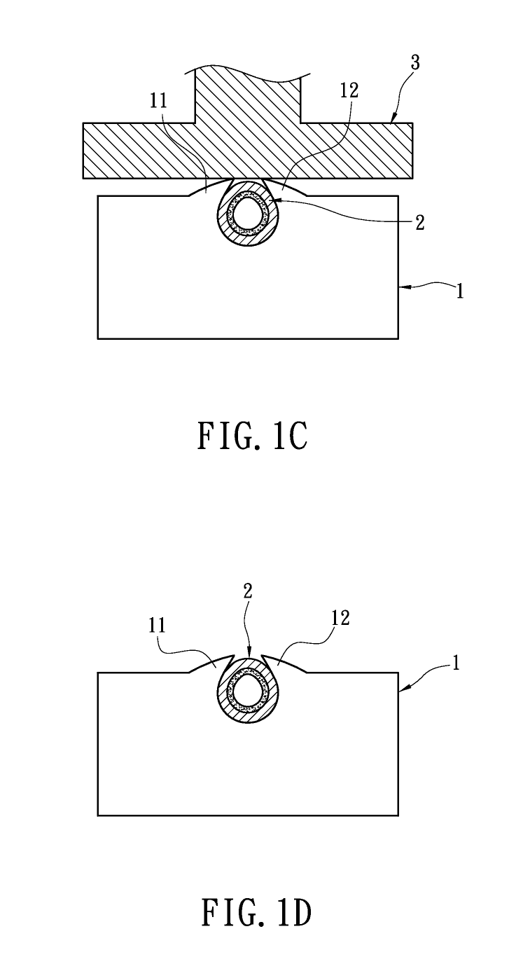

FIGS. 1A-1D show the connection of the first embodiment of the heat dissipation fin and a round heat pipe;

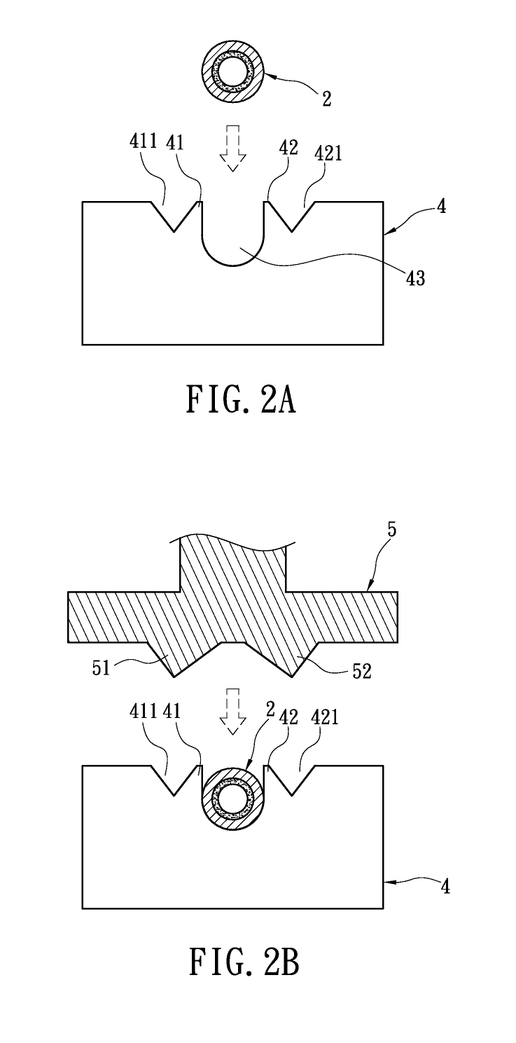

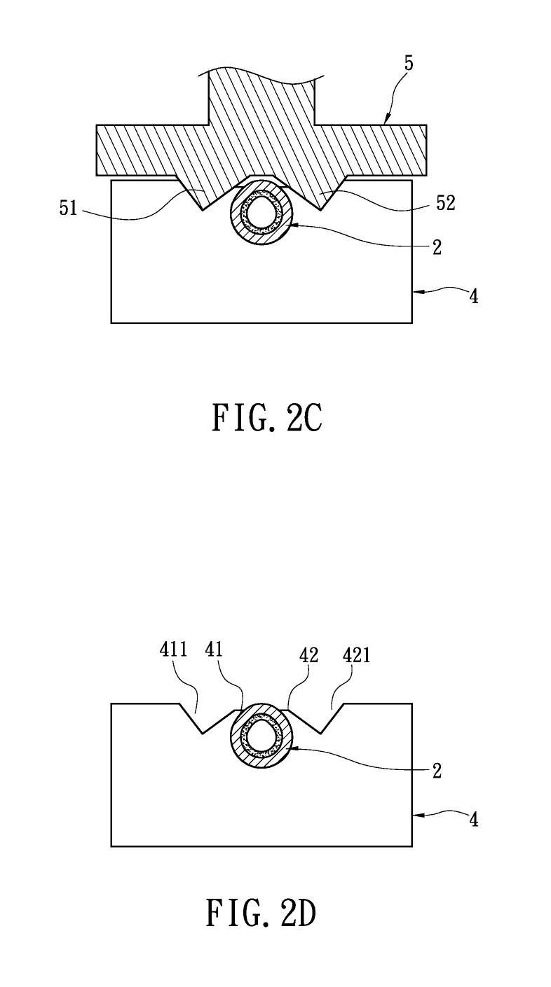

FIGS. 2A-2D show the connection the second embodiment of the heat dissipation fin and a round heat pipe;

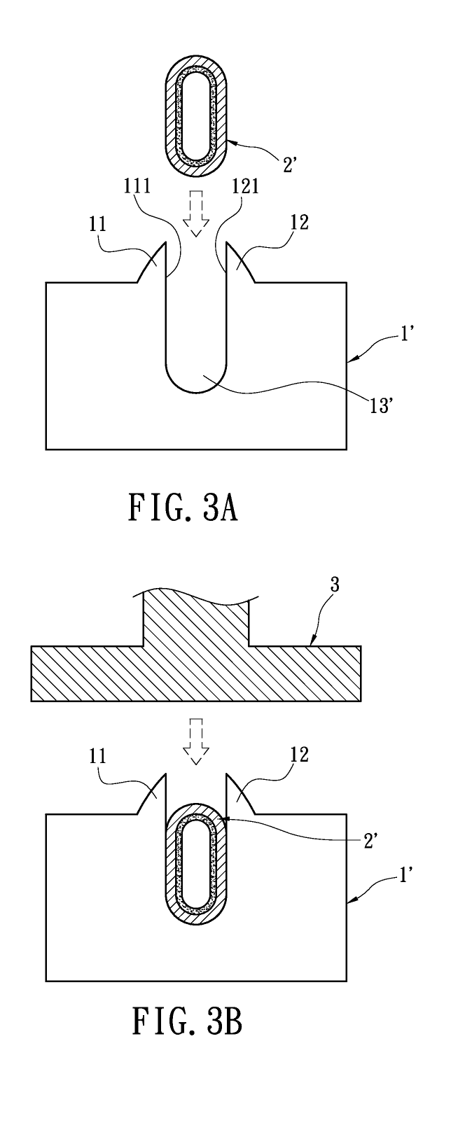

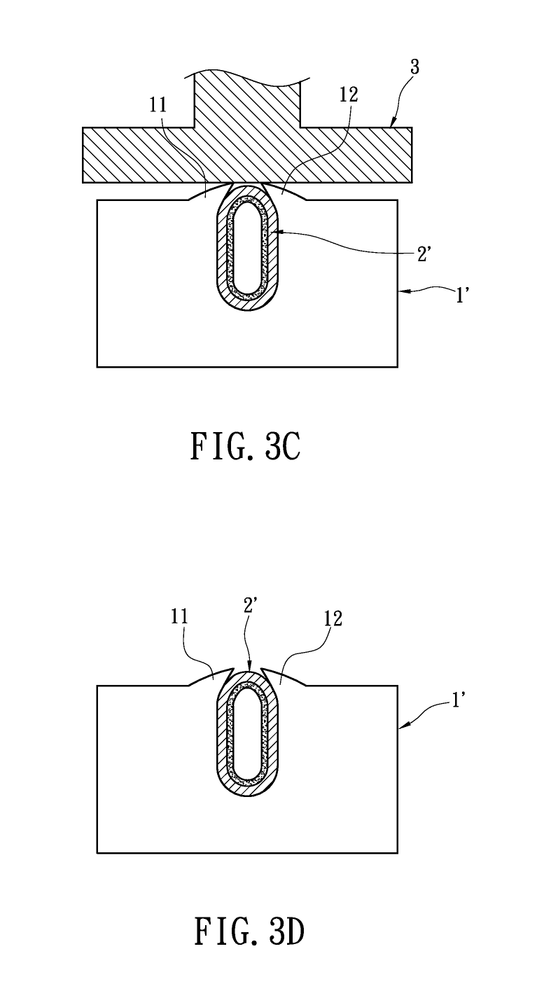

FIGS. 3A-3D show the connection of the first embodiment of the heat dissipation fin and an oval heat pipe; and

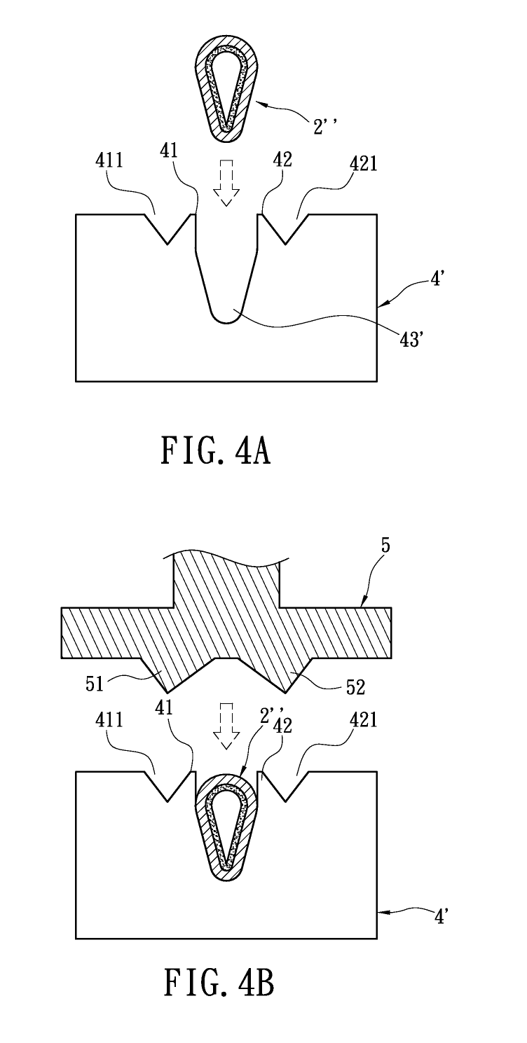

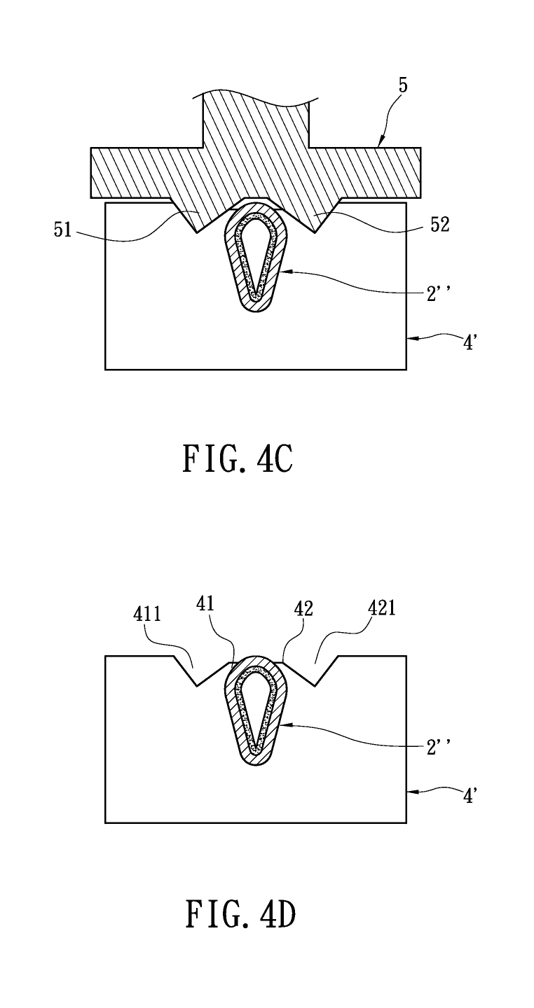

FIGS. 4A-4D show the connection of the second embodiment of the heat dissipation fin and a conic heat pipe.

### DETAILED DESCRIPTION OF THE INVENTION

Referring to FIGS. 1A and 1B, the method for connecting a fin and a heat pipe of the invention includes: providing a heat dissipation fin 1, wherein one side of the heat dissipation fin 1 is provided with a slot 13 for accommodating a heat pipe 2, and a width of the slot 13 is not larger than an outer diameter of the heat pipe 2; and placing the heat pipe 2 in the slot 13 to make an opening of the slot 13 inwards shrink to tightly grip the heat pipe 2.

FIGS. 1A-1D show the first embodiment of the invention. First, a heat dissipation fin 1 is provided. One side of the heat dissipation fin 1 is provided with a slot 13 for accommodating a round heat pipe 2. Both sides of an opening of the slot 13 outwards protrude two positioning portions 11, 12 separately. The two positioning portions 11, 12 incline inwards. Inner sides 111, 121 of the positioning portion 11, 12 are approximately aligned with two straight sides of the slot 13 separately, as shown in FIG. 1A. Second, the round heat pipe 2 is placed in the slot 13. Preferredly, a width of the slot 13 is not larger than an outer diameter of the round heat pipe 2 so that the round heat pipe 2 can be tightly accommodated in the slot 13. Next, a mold 3 having a plane is provided as shown in FIG. 1B. Then, the mold 3 presses the positioning portions 11, 12 as shown in FIG. 1C. Finally, the mold 3 is removed. The positioning portions 11, 12 are deformed to lean towards the inside of the slot 13 because of the inward inclination of the positioning portions 11, 12. The opening of the slot 13 shrinks inwards to make the slot 13 tightly grip the round heat pipe 2. The connection of round heat pipe 2 and the heat dissipation fin 1 is finished.

FIGS. 2A-2D show the second embodiment of the invention. First, a heat dissipation fin 4 is provided. One side of the heat dissipation fin 4 is provided with a slot 43 for accommodating a round heat pipe 2. Both sides of an opening of the slot 43 are provided with two positioning portions 41, 42 separately. Peripheries of the two positioning portions 41, 42 form two guiding grooves 411, 421. The positioning portions 41, 42 are triangular as shown in FIG. 2A. Second, the round heat pipe 2 is placed in the slot 43. Preferredly, a width of the slot 43 is not larger than an outer diameter of the round heat pipe 2 so that the round heat pipe 2 can be tightly accommodated in the slot 43. Next, a mold 5 having two protrusions 51, 52 corresponding to the guiding grooves 411, 421 is provided as shown in FIG. 2B. Then, the mold 5 presses the heat dissipation fin 4 and inserts the protrusions 51, 52 into the guiding grooves 411, 421 as shown in FIG. 2C. Finally, the mold 5 is removed. The positioning portions 41, 42 are deformed to lean towards the inside of the slot 43. The opening of the slot 43 shrinks inwards to make the slot 43 tightly grip the round heat pipe 2. The connection of round heat pipe 2 and the heat dissipation fin 4 is finished.

The invention can be applied in not only round heat pipe as shown in above embodiments but also heat pipes with other shapes. FIGS. 3A-3D show an embodiment of connecting the heat dissipation fin of the first embodiment with an oval heat pipe 2′. First, a heat dissipation fin 1′ is provided. One side of the heat dissipation fin 1′ is provided with a slot 13′ for accommodating an oval heat pipe 2′. Both sides of an opening of the slot 13′ outwards protrude two positioning portions 11, 12 separately. The two positioning portions 11, 12 incline inwards. Inner sides 111, 121 of the positioning portion 11, 12 are approximately aligned with two straight sides of the slot 13′ separately, as shown in FIG. 3A. Second, the oval heat pipe 2′ is placed in the slot 13′. Preferredly, a width of the slot 13′ is not larger than an outer diameter of the oval heat pipe 2′ so that the oval heat pipe 2′ can be tightly accommodated in the slot 13′. Next, a mold 3 having a plane is provided as shown in FIG. 3B. Then, the mold 3 presses the positioning portions 11, 12 as shown in FIG. 3C. Finally, the mold 3 is removed. The positioning portions 11, 12 are deformed to lean towards the inside of the slot 13′ because of the inward inclination of the positioning portions 11, 12. The opening of the slot 13′ shrinks inwards to make the slot 13′ tightly grip the oval heat pipe 2′. The connection of oval heat pipe 2′ and the heat dissipation fin 1′ is finished.

FIGS. 4A-4D show an embodiment of connecting the heat dissipation fin of the second embodiment with a conic heat pipe 2″. First, a heat dissipation fin 4′ is provided. One side of the heat dissipation fin 4′ is provided with a slot 43′ for accommodating a conic heat pipe 2″. Both sides of an opening of the slot 43′ are provided with two positioning portions 41, 42 separately. Peripheries of the two positioning portions 41, 42 form two guiding grooves 411, 421. The positioning portions 41, 42 are triangular as shown in FIG. 4A. Second, the round heat pipe 2″ is placed in the slot 43′. Preferredly, a width of the slot 43′ is not larger than an outer diameter of the conic heat pipe 2″ so that the conic heat pipe 2″ can be tightly accommodated in the slot 43′. Next, a mold 5 having two protrusions 51, 52 corresponding to the guiding grooves 411, 421 is provided as shown in FIG. 4B. Then, the mold 5 presses the heat dissipation fin 4′ and inserts the protrusions 51, 52 into the guiding grooves 411, 421 as shown in FIG. 4C. Finally, the mold 5 is removed. The positioning portions 41, 42 are deformed to lean towards the inside of the slot 43′. The opening of the slot 43′ shrinks inwards to make the slot 43′ tightly grip the round heat pipe 2″. The connection of round heat pipe 2″ and the heat dissipation fin 4′ is finished.

What is claimed is:

1. A connection method for a cooler, comprising the steps of:
a) providing a heat dissipation fin, wherein one side of the heat dissipation fin is provided with a slot, and both sides of an opening of the slot extend two positioning portions separately;
b) placing a heat pipe in the slot and providing a mold;
c) the mold pressing the positioning portions to make them inclined inwards so that the opening of the slot shrinks inwards to make the slot grip the heat pipe.

2. The method of claim 1, wherein inner sides of the positioning portion are approximately aligned with two straight sides of the slot separately

3. The method of claim 1, wherein the heat pipe is round or oval.

4. The method of claim 1, wherein the heat pipe is conic.

5. The method of claim 1, wherein a width of the slot is not larger than an outer diameter of the heat pipe so that the heat pipe can be tightly accommodated in the slot.

6. A connection method for a cooler, comprising the steps of:
a) providing a heat dissipation fin, wherein one side of the heat dissipation fin is provided with a slot, both sides of an opening of the slot is provided with two positioning portions separately, and a periphery of each the positioning portion forms a guiding groove;
b) placing a heat pipe in the slot and providing a mold having two protrusions corresponding the guiding grooves;
c) the mold pressing the heat dissipation fin and inserting the protrusions into the guiding grooves to make the positioning portions inclined inwards so that the opening of the slot shrinks inwards to make the slot grip the heat pipe.

7. The method of claim 6, wherein the positioning portions are triangular.

8. The method of claim 6, wherein the heat pipe is round or oval.

9. The method of claim 6, wherein the heat pipe is conic.

10. The method of claim 6, wherein a width of the slot is not larger than an outer diameter of the heat pipe so that the heat pipe can be tightly accommodated in the slot.

11. A connection method for a cooler, comprising the steps of:
a) providing a heat dissipation fin, wherein one side of the heat dissipation fin is provided with a slot for accommodating a heat pipe, and a width of the slot is not larger than an outer diameter of the heat pipe so that the heat pipe can be tightly accommodated in the slot; and
b) placing the heat pipe in the slot to make the heat pipe gripped by the shrunk slot.

12. The method of claim 11, wherein both sides of an opening of the slot extend two positioning portions separately, and a mold is provided to press the positioning portions so that the opening of the slot shrinks inwards.

13. The method of claim 11, wherein both sides of an opening of the slot is provided with two positioning portions separately, and a periphery of each the positioning portion forms a guiding groove, a mold having two protrusions corresponding the guiding grooves is provided, and the protrusions are inserted into the guiding grooves when the mold presses the heat dissipation fin so that the opening of the slot shrinks inwards.

14. The method of claim 11, wherein the heat pipe is round, conic or oval.

15. The method of claim 12, wherein the heat pipe is round, conic or oval.

16. The method of claim 13, wherein the heat pipe is round, conic or oval.
